(19) United States
(12) Patent Application Publication
(10) Pub. No.: US 2012/0189500 A1
(43) Pub. Date: Jul. 26, 2012

(54) Large Scale Energy Efficient CO2 Sequestration and Processing

(76) Inventors: James Charles Juranitch, Ft. Lauderdale, FL (US); Thomas R. Juranitch, DelRay Beach, FL (US)

(21) Appl. No.: 13/320,404

(22) PCT Filed: May 11, 2010
(86) PCT No.: PCT/US10/01411

§ 371 Date: Apr. 6, 2012

Related U.S. Application Data
(60) Provisional application No. 61/215,959, filed on May 11, 2009.

(51) Int. Cl. B01D 53/75; B01D 53/84; B01D 53/74

(52) U.S. Cl. 422/139; 422/168; 422/162; 422/170; 422/169; 422/173

(57) ABSTRACT

A system for treating an exhaust stream issued by a power plant processes the exhaust stream in a methanol reactor. The exhaust stream contains CO and/or CO₂, and can be a full stack or a partial stack exhaust stream. The methanol reactor is a pellet style of methanol reactor, and can be a foam or an alpha alumina oxide foam reactor. A plasma chamber generates H₂ for reacting in the methanol reactor. A portion of the exhaust stream issued by the power plant is consumed in the plasma chamber. An algae reactor converts sequestered CO₂ to O₂. The algae is exposed to the exhaust stream to extract nutrients therefrom and thereby augment growth of the algae. The plasma chamber receives at a high temperature region thereof CO that is reduced to its elemental state. Cooling of the exhaust stream and precipitates the methanol to be re-burned as a fuel.

### RELATIONSHIP TO OTHER APPLICATION

This application claims the benefit of the filing date of U.S. Provisional Patent Application Ser. No. Ser. No. 61/215,959; filed May 11, 2009; Conf. No. 7139; Foreign Filing License Granted; in the name of James C. Juranitch, the same inventor as herein. The disclosure in the identified U.S. Provisional Patent Application is incorporated herein by reference.

### BACKGROUND OF THE INVENTION

1. Field of the Invention

This invention relates generally to a system for treating the exhaust output of a power plant, and more particularly, to a system wherein carbon neutral or carbon negative feed stocks such as biomass and algae are used to reduce greenhouse gas emissions into the atmosphere.

2. Description of the Related Art

The world is concerned with global climate change. Previously this was called global warming but current thought directs us to think of it more as a global climate change. Many feel man, and more specifically green house gasses are responsible for a significant part of global climate change. This invention teaches an efficient method of sequestering CO₂ and, or CO from an exhaust stream. The CO or CO₂ can then be converted to methanol and used as a transportable fuel, or burned in the manufacturing process that required heat. When carbon neutral or carbon negative feed stocks such as biomass and algae are used, green house gas emissions into the atmosphere are significantly reduced.

There is a need for a CO₂ sequestering system that is energy efficient, more cost effective, and smaller in size, than conventional system for treating an exhaust stream from a power plant.

### SUMMARY OF THE INVENTION

The foregoing and other objects are achieved by this invention which provides a system for treating an exhaust stream issued by a power plant, the system comprising the step of processing the exhaust stream in a methanol reactor.

In respective embodiments of the invention, the exhaust stream contains CO and/or CO₂. The exhaust stream is, in some embodiments of the invention, a full stack exhaust stream.

In a further embodiment, the methanol reactor is a pellet style of methanol reactor. In other embodiments of the invention, it is a foam or an alpha alumina oxide foam reactor.

There is further provided a plasma chamber for generating H₂ for reacting in the methanol reactor. A portion of the exhaust stream issued by the power plant is consumed in the plasma chamber.

In some embodiments of the invention, there is further provided a fluidized bed for generating H₂. In other embodiments, a steam process is used for generating the H₂. In still further embodiments, there is provided a steam reformation process for generating the H₂. Also, a secondary steam reformation process that is powered by the sensible heat in a plasma exhaust, will generate additional amounts of H₂. Moreover, a hydrolysis will be used in some embodiments of the invention for generating H₂.

An algae reactor is used in some embodiments of the invention for converting sequestered CO₂ to O₂. The algae is exposed to the exhaust stream of the power plant to extract nutrients therefrom and thereby augment the growth of the algae.

In a further embodiment, there is provided a plasma chamber for receiving at a high temperature region thereof CO that is thereby reduced to its elemental state.

In a highly advantageous embodiment, the exhaust stream and methanol are cooled to a temperature under 65° C. to cause liquid methanol to precipitate out. In some embodiments of the invention, the methanol is re-burned as a fuel.

In accordance with a further system aspect of the invention, there is provided a plasma chamber for receiving at a high temperature region thereof CO that is reduced to its elemental state.

### BRIEF DESCRIPTION OF THE DRAWING

Comprehension of the invention is facilitated by reading the following detailed description, in conjunction with the annexed drawing, in which:

FIG. 1 is a simplified schematic representation of a plurality of power plants issue greenhouse gas exhaust that is treated in a methanol reactor and a methanol condensate system; and

FIG. 2 is a simplified schematic representation of a further embodiment of the system shown in FIG. 1, wherein a plurality of power plants issue greenhouse gas exhaust that is treated in a methanol reactor and a methanol condensate system.

### DETAILED DESCRIPTION

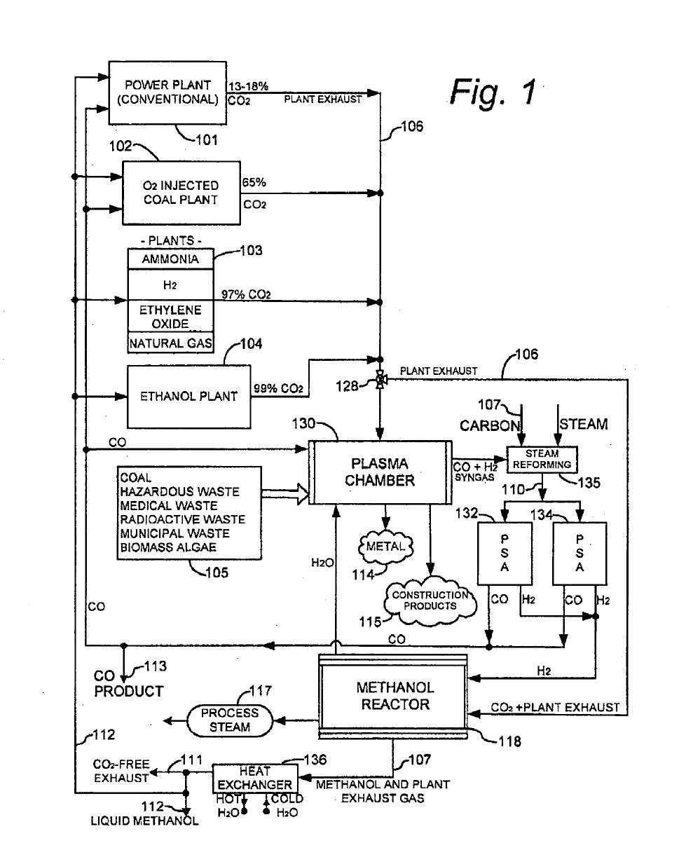

FIG. 1 shows a number of plants, specifically conventional power plant 101, O₂ injected coal plant 102, plants 103 (ammonia, H₂, ethylene oxide, and natural gas) that produce CO₂. Coal fired conventional power plant 101 emits about 2 lbs of CO₂ per kW-hr. A cleaner competitor is a conventional natural gas power plant would look substantially the same, yet would emit only about 1.3 Lbs of CO₂ per kW-hr. All such plants are significant contributors to the global inventory of greenhouse gasses.

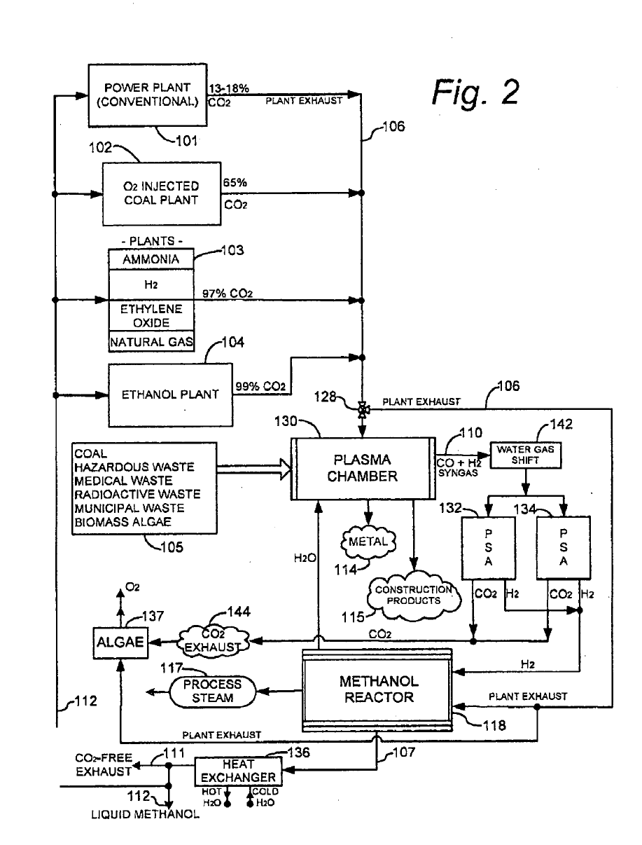

Plants 102, 103, and 104 are illustrate increasing concentrations of CO₂ per plant exhaust volume. However, the low ratio of CO₂ per exhaust volume issued by power plant 101 renders sequestration of CO₂ expensive and difficult. Some power plant systems have been demonstrated as able to achieve less expensive and less difficult CO₂ sequestration, but they are capital and energy intensive. After the CO or CO₂ is sequestered it still has to be stored in a conventional sequestering system. Moreover, the storage of CO₂ is expensive and controversial. However, the present invention enables the processing of CO₂ on site, and the storage thereof is not necessary. This is particularly feasible when carbon neutral, or carbon negative, feed stocks are used, such as algae. Post processing of the CO₂ in an algae reactor, such as algae reactor 137 (FIG. 2) enables carbon negative operation.

Referring to FIG. 1, plant exhaust stream 106 is delivered to a plasma chamber 130 and then to a methanol reactor 118. A small percentage of the flow is typically fed into plasma reactor 130. Methanol reactor 118 is, in some embodiments of the invention, a copper, zinc oxide, alumina reactor, but can be any composition that converts CO₂. Plasma chamber 130 is used as a hydrogen generator. In the practice of the invention, any suitable hydrogen generator can be used. However, in the present state of the art a plasma reactor is one of the most efficient, and therefore shown in this embodiment of the invention. In other embodiments, a conventional gassifier (not shown) or fluidized bed (not shown) can also be used.

Plasma chamber 130 can be supplied from any of several feed stocks. These include a fossil fuel such as coal, hazardous waste, medical waste, radioactive waste, municipal waste, or a carbon negative fuel such as algae. The plasma chamber will exhausts a product gas that consists primarily of syngas at a temperature, in this specific illustrative embodiment of the invention, of approximately 1200° C. This flow contains considerable sensible heat energy that is be extracted at flow stream 110 to make carbon efficient electrical or steam power. A steam reforming process 135 is operated directly in the high temperature plasma flow stream, or indirectly in a closed loop heat transfer system to generate additional H₂.

Carbon, which is provided at carbon inlet 107, is obtained from conventional sources such as methane (not shown), or from unconventional sources such as semi-spent fly ash (not shown). Syngas 110 then is processed through pressure swing absorbers (PSAs) 132 and 134 to separate the H₂ from the CO. In the practice of the invention, any conventional form of separation system, such as membranes (not shown), aqueous solutions (not shown), molecular sieves, (not shown), etc. can be used in other embodiments of the invention to separate out the H₂. The H₂ then is delivered to methanol reactor 118 where it is combined plant exhaust flow 106. In some embodiments of the invention, reactor 118 can employ copper, zinc oxide, alumina reactor, or any other type of methanol catalytic material.

Reactor 118 can, in respective embodiments of the invention, be a conventional or a foam reactor or it could be an alpha alumina oxide foam reactor in an idealized application. Alpha alumina oxide foam reactors accommodate a considerably larger flow rate that conventional reactors, such increased flow being advantageous in the practice of the invention.

Plant exhaust 106 and H₂ react exothermically in methanol reactor 118. The resulting heat is, in this embodiment of the invention, extracted as steam 117 that can be used in numerous parts of the process herein disclosed, such as in plasma reactor 130, steam reformation chamber 135, or as municipal steam. The combined methanol and exhaust gas at methanol reactor outlet 107 are then delivered, in this embodiment, to heat exchanger 136. Using cold water in this embodiment, heat exchanger 136 brings the temperature of the gaseous mixture below 65° C., which precipitates out the product methanol in a liquid form at liquid methanol outlet 112 at a pressure of one atmosphere or higher. The liquid form of methanol at liquid methanol outlet 112 is separated from the CO and or CO₂ depleted plant exhaust which then, in this specific illustrative embodiment of the invention, is exhausted to the atmosphere from CO₂-free exhaust outlet 111. The liquid methanol can be sold for fuel, or recycled into any of the plants to produce heat.

The CO from the syngas, which is available in this embodiment of the invention at CO product outlet 113, can be sold as a product, or in some embodiments of the invention, re-introduced into plasma chamber 130 at the high temperature zone thereof (not shown), which can operate at approximately 7000° C., to be reduced into elemental forms of carbon and oxygen. This process can be aided, in some embodiments, by microwave energy, magnetic plasma shaping, UHF energy, electron beam energy, corona discharge, or laser energy (not shown). Additionally, the CO can be re-introduced into the plant to be burned as fuel that yields approximately 323 BTU/cu ft.

FIG. 2 is a simplified schematic representation of a further embodiment of the system shown in FIG. 1, wherein a plurality of power plants issue greenhouse gas exhaust that is treated in a methanol reactor and a methanol condensate system. Elements of structure that have previously been discussed are similarly designated. In this figure, there is shown a further example of the process wherein there is provided a gas shift reaction 142 that is disposed downstream of the syngas generating plasma chamber 130. A steam reformation system 135 (FIG. 1) can optionally be employed in the embodiment of FIG. 2. The CO₂ that has been separated by operation of PSAs 132 and 134 is, in this embodiment of the invention, processed by an algae reactor 137. Algae reactor 137 is, in some embodiments, a photoreactor or a hybrid pond. In addition, a portion of plant exhaust 106 is processed by the algae to provide growth accelerating elements such as nitrogen. Any conventional process other than PSAs can be used in other embodiments of the invention to separate the CO₂ from the shifted syngas.

Although the invention has been described in terms of specific embodiments and applications, persons skilled in the art can, in light of this teaching, generate additional embodiments without exceeding the scope or departing from the spirit of the invention described herein. Accordingly, it is to be understood that the drawing and description in this disclosure are proffered to facilitate comprehension of the invention, and should not be construed to limit the scope thereof.

Although the invention has been described in terms of specific embodiments and applications, persons skilled in the art may, in light of this teaching, generate additional embodiments without exceeding the scope or departing from the spirit of the invention described and claimed herein. Accordingly, it is to be understood that the drawing and description in this disclosure are proffered to facilitate comprehension of the invention, and should not be construed to limit the scope thereof.

What is claimed is:

1. A system for treating an exhaust stream issued by a power plant, the system comprising the step of processing the exhaust stream in a methanol reactor.

2. The system of claim 1, wherein the exhaust stream contains CO.

3. The system of claim 1, wherein the exhaust stream contains CO₂.

4. The system of claim 1, wherein the exhaust stream is a selectable one of full stack exhaust stream and a partial stack exhaust stream.

5. The system of claim 1, wherein the methanol reactor is a pellet style of methanol reactor.

6. The system of claim 1, wherein the methanol reactor is a selectable one of an alpha alumina oxide foam reactor and a foam reactor.

7. The system of claim 1, wherein there is further provided a plasma chamber for generating H₂ for reacting in the methanol reactor.

8. The system of claim 7, wherein a portion of the exhaust stream issued by the power plant is consumed in the plasma chamber.

9. The system of claim 1, wherein there is further provided a fluidized bed for generating H₂.

10. The system of claim 1, wherein there is further provided a steam process for generating H₂.

11. The system of claim 1, wherein there is further provided a steam reformation process for generating H₂.

12. The system of claim 11, wherein there is further provided a secondary steam reformation process that is powered by the sensible heat in a plasma exhaust, for generating additional amounts of H₂.

13. The system of claim 1, wherein there is further provided a hydrolysis process for generating H₂.

14. The system of claim 1, wherein there is further provided an algae reactor for converting sequestered CO₂ to O₂.

15. The system of claim 1, wherein algae is exposed to the exhaust stream of the power plant to extract nutrients from the exhaust stream to augment the growth of the algae.

16. The system of claim 1, wherein there is further provided a plasma chamber for receiving at a high temperature region thereof CO that is reduced to its elemental state.

17. The system of claim 1, wherein the exhaust stream and methanol are cooled to a temperature under 65° C. to cause liquid methanol to precipitate out.

18. The system of claim 1, wherein methanol is re-burned as a fuel.

19. A system for treating an exhaust stream issued by a power plant, the system comprising a plasma chamber for receiving at a high temperature region thereof CO that is reduced to its elemental state.
